(19) United States
(12) Patent Application Publication
(10) Pub. No.: US 2008/0307272 A1
(43) Pub. Date: Dec. 11, 2008

(54) BACKBONE TRANSMISSION APPARATUS AND METHOD HAVING APPARATUS INTERNAL ALARM SUPPRESSION FUNCTION

(76) Inventor: KIMIO OZAWA, Tokyo (JP)

Correspondence Address: NEC CORPORATION OF AMERICA, 6535 N. STATE HWY 161, IRVING, TX, 75039, US

(21) Appl. No.: 12/051,706

(22) Filed: Mar. 19, 2008

(30) Foreign Application Priority Data
Mar. 22, 2007 (JP) 2007-074942

(51) Int. Cl. G06F 11/30

(52) U.S. Cl. 714/48; 714/E11.179

(57) ABSTRACT

Disclosed is a backbone transmission apparatus including a plurality of main signal packages and a monitoring control package connected to the plurality of main signal packages each via an apparatus internal bus. When a failure occurs in one of the main signal packages, the main signal package generates mask request information for requesting the suppression of an alarm and sends the generated mask request information to the monitoring control package via the apparatus internal bus. The monitoring control package receives the mask request information, determines a main signal package to be masked based on path information on a main signal, and sends mask control information, which is used for suppressing an alarm notification to the monitoring control package, to the main signal package to be masked via the apparatus internal bus. When the mask control information is received, the main signal package to be masked performs mask processing for an alarm to be notified to the monitoring control package.

### REFERENCE TO RELATED APPLICATION

This application is based upon and claims the benefit of the priority of Japanese patent application No. 2007-074942, filed on Mar. 22, 2007, the disclosure of which is incorporated herein in its entirety by reference thereto.

### FIELD OF THE INVENTION

The present invention relates to a backbone transmission system, and more particularly to a backbone transmission apparatus and method that have the apparatus internal alarm suppression function.

### BACKGROUND OF THE INVENTION

A backbone transmission apparatus such as a WDM (Wavelength Division Multiplex) does not have the function to change the main signal path. So, when a primary failure occurs in one main signal package and a primary alarm (primary cause alarm) is generated therein, the main signal packages, in which the generation of a secondary alarm (alarm generated by non-primary cause) is to be suppressed, are predetermined. Because the main signal packages located in the downstream of a main signal package where a primary alarm is generated are uniquely identified, there is no need for controlling the suppression of a secondary failure according to the paths.

Recently, to meet the need for flexibility in the path design of a backbone network, a ROADM (Reconfigurable Optical Add Drop Multiplexer) device is developed. The ROADM device, which uses the optical signals of various wavelengths as the main signal, is required to have the function to change a path without converting an optical signal to an electrical signal. To switch a path, the ROADM device uses means such as an optical switch. The ROADM device can change a main signal path, but cannot transmit information for suppressing an alarm because it does not have the electrical interface or overhead information for suppressing the alarm.

There is disclosed a device that has the function to mask an alarm output, generated in a lower-layer signal termination unit in response to a failure in a upper-layer signal termination unit of the device. For example, Patent Document 1 discloses the configuration of a multiple-layer signal termination device comprising multiple layer signal termination units each of which comprises an alarm mask signal generation unit that generates an alarm mask signal for the lower-layer based on detected failure information and information from an alarm mask control information storage unit, a layer alarm output unit that masks or does not mask an alarm output corresponding to a failure detected in its own layer based on the alarm mask signal detected by an alarm mask signal detection unit and the information from the alarm mask control information storage unit, and an alarm mask control information storage unit in which alarm mask control information is stored wherein pre-set alarm mask control information is changed to flexibly process various device user requests about the alarm output mask function. This configuration uses a dedicated communication path for masking an alarm, other than that for the main signal.

As an alarm mask control device, there is also disclosed an alarm collection device in Patent Document 2 that collects various alarms generated in a monitored device and masks an alarm as necessary. This alarm collection device comprises a communication unit that receives mask control information from, and sends alarm information to, the upper-level monitoring device, a mask control analysis unit that analyzes the mask control information received from the upper-level monitoring device and sends the generated mask instruction information to a mask unit, and the mask unit that masks alarms collected in the monitored device according to mask instruction information. Patent Document 2 discloses only the configuration of the mask control of an alarm notification between the upper-level monitoring device and the alarm collection device in the monitored device. As described above, Patent Documents 1 and 2 disclose only the configurations completely different from that disclosed by the present invention that will be described later.

[Patent Document 1] Japanese Patent Kokai Publication No. JP-A-9-116598

[Patent Document 2] Japanese Patent Kokai Publication No. JP-A-8-298533

### SUMMARY OF THE DISCLOSURE

The following analyses are given by the present invention. The entire disclosures of the above mentioned patent documents are incorporated herein by reference thereto.

As described above, a device such as the ROADM device can change the path of the main signal but, because the electrical interface and the overhead information are not provided, cannot transmit information for suppressing an alarm.

Accordingly, it is an object of the present invention to provide an apparatus and a method that control the path of alarm suppression information and, when a failure occurs in a main signal package, prevent the failure from affecting other main signal packages and generating a secondary alarm.

The present invention disclosed in this application provides the following general configuration.

In a backbone transmission apparatus comprising multiple packages through which a main signal is transmitted, the present invention provides a monitoring control package that holds path information to control a path through which information for alarm suppression is transmitted. When a primary alarm is generated in one main signal package, the monitoring control package collects an alarm via an apparatus internal bus and transmits a suppression signal to other main signal packages, which will be affected by the primary alarm, to suppress a secondary alarm.

According to one aspect of the present invention, there is provided an apparatus comprising a plurality of main signal packages; and a monitoring control package connected to the plurality of main signal packages each via an apparatus internal bus wherein, when a failure occurs in one of the main signal packages, the main signal package generates mask request information and sends the generated mask request information to the monitoring control package via the apparatus internal bus, and the monitoring control package receives the mask request information from the main signal package, determines a main signal package to be masked based on path information, and sends mask control information, which is used for masking an alarm notification to the monitoring control package, to the main signal package to be masked via the apparatus internal bus. When the mask control information is received, the main signal package to be masked performs mask processing.

According to one aspect of the present invention, there is provided an alarm control method for use in a backbone transmission apparatus comprising a plurality of main signal packages; and a monitoring control package connected to the plurality of main signal packages each via an apparatus internal bus. The alarm control method is performed by the monitoring control package and comprises the steps of collecting an alarm about a failure, generated in one of the main signal packages, via the apparatus internal bus; and sending a control signal, used for masking an alarm notification, to other main signal packages, which will be effected by the failure, via the apparatus internal bus.

According to another aspect of the present invention, there is provided a monitoring control package apparatus connected to a plurality of main signal packages each via an apparatus internal bus, comprising means that receives mask request information from a main signal package in which a failure occurs, the mask request information being generated by the main signal package for requesting a suppression of an alarm; means that determines a main signal package to be masked based on path information on a main signal and generates mask control information, the mask control information being used for suppressing an alarm notification to the monitoring control package; and means that sends the mask control information to the main signal package to be masked via the apparatus internal bus.

According to still another aspect of the present invention, there is provided a main signal package apparatus connected to a monitoring control package connected via an apparatus internal bus. The main signal package apparatus comprises means that generates mask request information when a failure occurs and sends the generated mask request information to the monitoring control package apparatus via the apparatus internal bus, the mask request information being used for requesting a suppression of an alarm.

According to still another aspect of the present invention, there is provided a main signal package apparatus connected to a monitoring control package connected via an apparatus internal bus wherein the monitoring control package receives mask request information from a main signal package in which a failure occurs, determines a main signal package to be masked based on path information on a main signal, and sends mask control information to the main signal package to be masked via the apparatus internal bus, the mask request information being used for requesting a suppression of an alarm, the mask control information being used for suppressing an alarm notification, and the main signal package to be masked comprises means that receives the mask control information and masks the alarm notification.

The meritorious effects of the present invention are summarized as follows.

When a failure occurs in a main signal package in a backbone transmission apparatus comprising multiple packages through which a main signal is transmitted and, as a result, the failure affects other main signal packages, the present invention provides the function to prevent the generation of an alarm (secondary alarm) which is not an alarm (primary alarm) generated by a primary cause and which is generated by a cause other than the primary cause.

### BRIEF DESCRIPTION OF THE DRAWINGS

FIG. 1 is a diagram showing the configuration of one example of the present invention.

FIG. 2 is a diagram showing the configuration of another example of the present invention.

FIG. 3 is a sequence diagram showing an example of the operation in one example of the present invention.

### PREFERRED MODES OF THE INVENTION

Examples of the present invention will be described more in detail with reference to the drawings.

A backbone transmission apparatus according to the present invention has a monitoring control package (20) that monitors multiple packages through which the main signal is transmitted. The monitoring control package (20) and each of main signal packages (10) is connected via a communication bus (apparatus internal bus) (40) in the apparatus for transmitting setting information, alarm information, and performance information. When a primary alarm is generated in a main signal package, the monitoring control package (20) collects the alarm via the apparatus internal bus (40) and sends a suppression signal to other main signal packages, which will be affected, to suppress a secondary alarm.

A WDM (Wavelength Division Multiplexer) and a ROADM (Reconfigurable Optical Add Drop Multiplexer) may have a device configuration in which the optical signals of different wavelengths are used as the main signal and there is no electrical interface between the main signal packages. Even in this case, providing the apparatus internal bus (40) among the monitoring control package (20) and the main signal package (10) allows a secondary alarm from being suppressed without providing a dedicated bus among the main signal packages for transmitting alarm suppression information.

The ROADM device has the function to select the path of the main signal (Add, Drop, Through, Drop and Continue).

When the path of the main signal is changed, the connection status among the main signal packages in the apparatus, as well as the locations at which a secondary alarm is generated, is also changed.

According to the present invention, the monitoring control package (20) recognizes a change in the connection status and suppresses a secondary alarm in a package where its suppression is required, thus appropriately providing alarm suppression. The following describes the present invention with reference to examples.

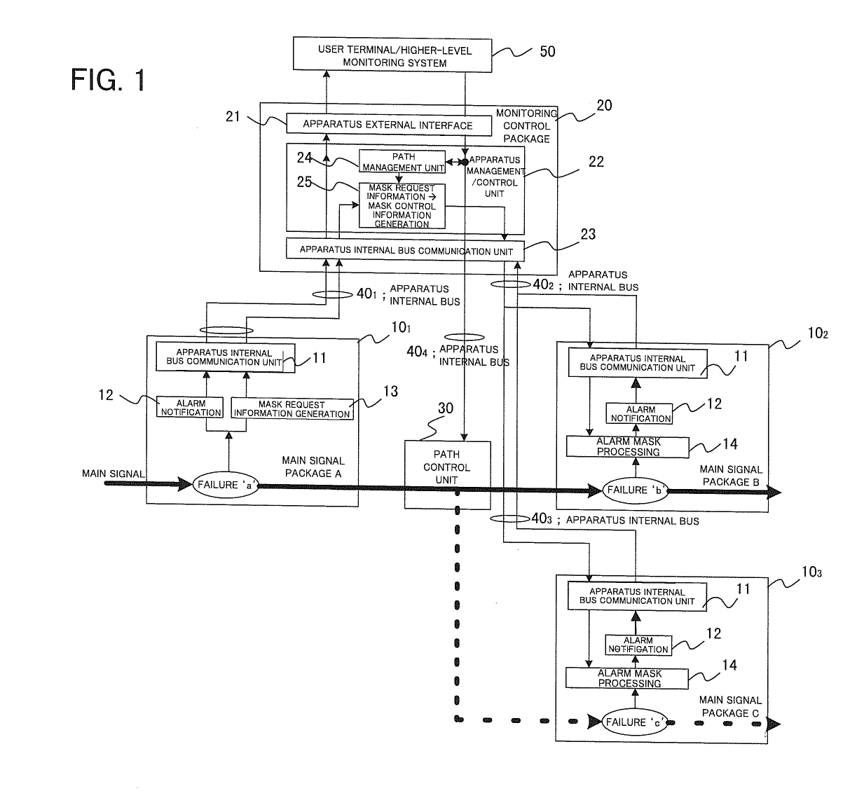

FIG. 1 is a diagram showing the configuration of a backbone transmission apparatus in one example of the present invention. Referring to FIG. 1, the backbone transmission apparatus comprises a monitoring control package 20 that monitors and controls the apparatus in its entirety, multiple main signal packages 10₁, 10₂, and 10₃, a user terminal/upper-level monitoring system 50, and a path control unit 30. The monitoring control package 20 and the main signal packages 10₁, 10₂, and 10₃ are connected via apparatus internal buses 40₁, 40₂, and 40₃.

The monitoring control package 20 comprises an apparatus external interface 21, an apparatus management/control unit 22, and an apparatus internal bus communication unit 23. The apparatus external interface 21, connected to the user terminal/upper-level monitoring system 50, accepts an operation instruction from the user (manager).

The apparatus management/control unit 22 has the function to monitor and control the apparatus according to an instruction from the user.

The apparatus internal bus communication unit 23 communicates with the main signal packages 10 via the apparatus internal buses 40.

When the apparatus internal bus communication unit 23 receives mask request information transmitted from the main signal packages 10 via the apparatus internal bus 40, the apparatus management/control unit 22 stores the received mask request information therein (means 25). The apparatus management/control unit 22 has means (25) that determines which main signal package 10 is to be masked based on the main signal path information stored in a path management unit 24 and generates mask control information. The mask control information created by the apparatus management/control unit 22 is transmitted to the main signal packages 10, which are to be masked, via the apparatus internal bus communication unit 23.

The main signal package 10 processes and monitors the main signal and detects if there is a failure in the main signal. The main signal package 10 has an apparatus internal bus communication unit 11 for performing communication with the monitoring control package 20.

The main signal package (A) 10₁ comprises alarm notification means 12 that creates an alarm when a failure occurs in the main signal and notifies the created alarm to the monitoring control package 20 and mask request information generation means 13 that generates mask request information for suppressing a secondary failure notification, and notifies the generated mask request information to the monitoring control package 20.

Each of the main signal packages (B, C) 10₂ and 10₃ comprises alarm mask processing means 14 that, when mask control information is received from the monitoring control package 20 via apparatus internal bus 40₂ or 40₃, prevents the alarm notification means 12 from notifying a failure, generated in its package, to the monitoring control package 20.

The path control unit 30 has the function that, when the path control operation is performed via the user terminal/upper-level monitoring system 50, receives the control signal for controlling the path from the monitoring control package 20 via an apparatus internal bus 40₄ and, based on the control signal, switches the main signal paths.

Referring to FIG. 1, the following describes the operation of this example. The following describes a primary alarm notification, which is generated when a failure occurs in the main signal packages 10₁, and the function to suppress a secondary alarm notification.

When a main signal failure ‘a’ is generated in the main signal package (A) 10₁, the alarm detection function of the main signal package(A) 10₁ detects an alarm and notifies the monitoring control package 20 that the alarm has occurred. At this time, in addition to notifying that the alarm has occurred, the main signal package 10₁ generates mask request information, which prevents the alarm from being notified to other main signal packages that will be affected by the failure ‘a’, and sends the generated mask request information to the monitoring control package 20 via the apparatus internal bus 40₁.

The monitoring control package 20, which has the path management unit 24 that manages the path information on the main signal, identifies that the main signal package (A) 10₁ and the main signal package (B) 10₂ are now connected. The main signal path can be changed by an operation on the user terminal/upper-level monitoring system 50 and, so, the connection may be changed to the connection between the main signal package (A) 10₁ and the main signal package (C) 10₃. In this example, it is assumed that the main signal package (A) 10₁ and the main signal package (B) 10₂ are connected. That is, the path connection relation indicates that the mask request information from the main signal package (A) 10₁ should be sent to the main signal package (B) 10₂. When a failure occurs in the main signal package (A) 10₁, there is a possibility that the main signal package (B) 10₂, which is located in the downstream, will be affected and that the main signal package (B) 10₂ notifies a secondary failure. To easily identify the cause of a failure, it is necessary that only the alarm generated by the primary cause should be notified and that the alarm generated by the secondary cause should be suppressed.

Based on the path management information in the path management unit 24 that indicates that the main signal package (A) 10₁ and the main signal package (B) 10₂ are connected, the monitoring control package 20 generates mask control information, which will be sent to the main signal package (B) 10₂, from the mask request information received from the main signal package (A) 10₁. The monitoring control package 20 sends the generated mask control information to the main signal package (B) 10₂ via the apparatus internal bus 40₂.

The main signal package (B) 10₂, where the failure ‘b’ that is a secondary failure is detected, receives the mask control information from the monitoring control package 20. This mask control information causes the alarm mask processing means 14 to suppress the alarm notification and, as a result, no alarm is notified to the monitoring control package 20. The above operation allows a backbone transmission apparatus, where the main signal path can be selected in the apparatus, to suppress an alarm appropriately.

This example achieves the following effect.

The configuration of this example suppresses a failure notification generated by the secondary cause and notifies the user only about an alarm generated by the primary cause. As a result, the search for a failure becomes easy, and the time to the failure recovery can be reduced.

This configuration eliminates the need for a dedicated bus in the apparatus specifically provided for suppressing an alarm. Thus, the hardware configuration of the apparatus can be simplified, and the cost can be reduced.

Because the function implemented in the apparatus is multi-purpose, the function of the apparatus can be extended easily. That is, the apparatus internal bus, which is always provided in a main signal package, is used and, so, failure notification suppression means can be provided in a new main signal package, which will be added in future, with no need to add a special function.

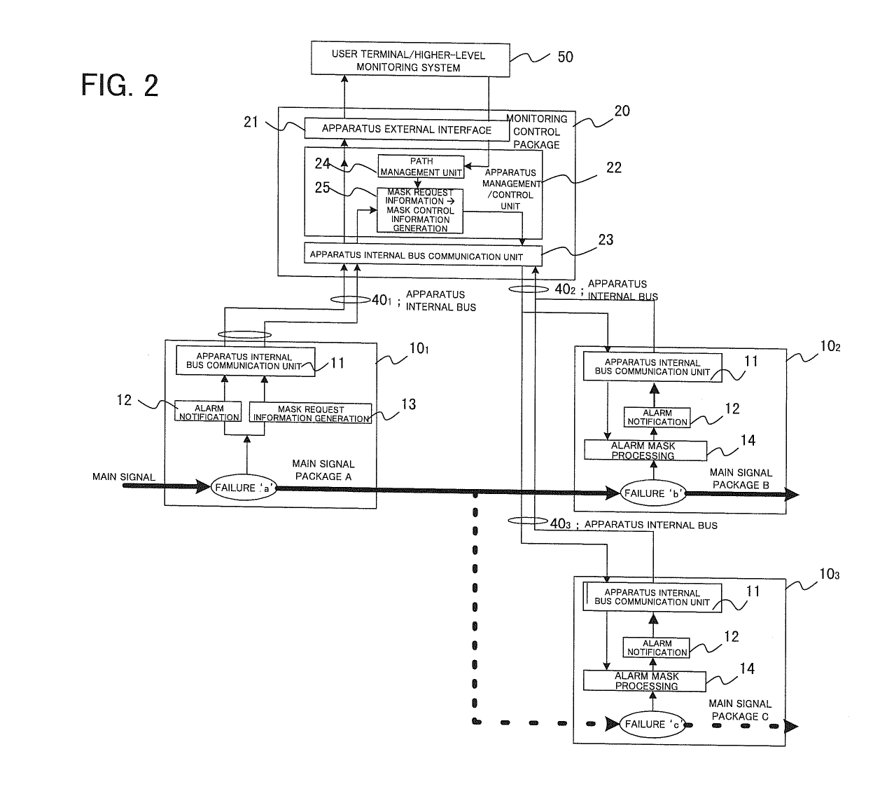

Next, another example of the present invention will be described. FIG. 2 is a diagram showing the configuration of a second example of the present invention. The configuration shown in FIG. 2 differs from that shown in FIG. 1 in that the path control unit 30 is not provided. The rest of the configuration is the same as that of the example shown in FIG. 1. In this example, a field engineer connects the optical patch cords for controlling the paths. In this case, to allow a path management unit 24 of an apparatus management/control unit 22 to get the path information, the path information is set via a user terminal/upper-level monitoring system 50.

In this example, the path information is used, not for controlling the path of the main signal, but for allowing the apparatus management/control unit 22 to identify a path on which an alarm is to be suppressed. In this example, the notification of a secondary alarm can be suppressed as in the example shown in FIG. 1.

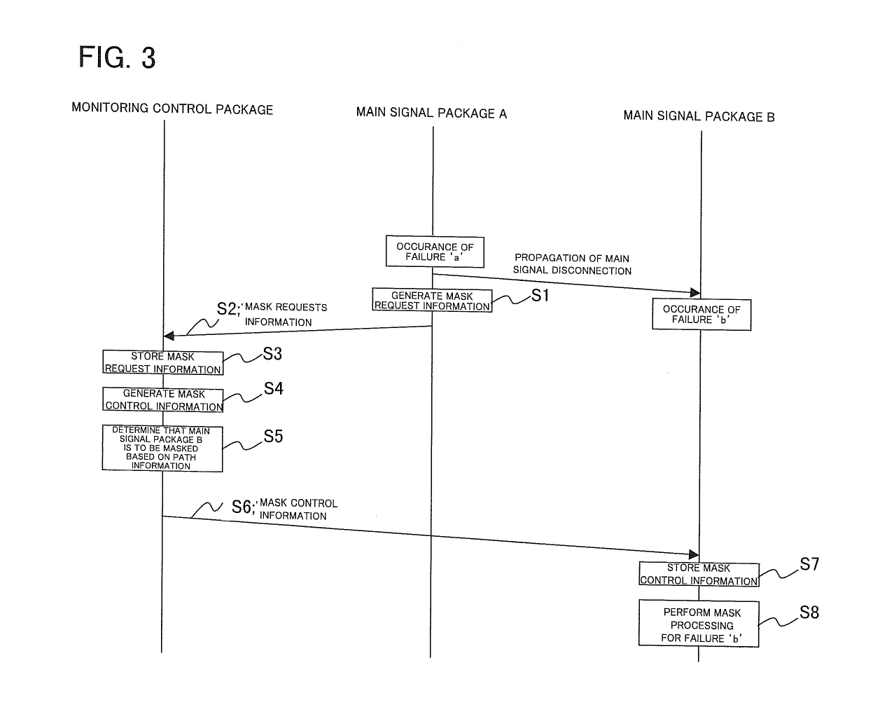

FIG. 3 is a sequence diagram showing an example of the operation of the examples described above. The following describes the operation of the examples with reference to FIG. 3.

When a failure ‘a’ occurs in main signal package A, main signal package A generates the mask request information (S1) and sends the generated mask request information to the monitoring control package via the apparatus internal bus (S2). Note that, when the failure ‘a’ is generated, the main signal to be sent to main signal package B in the downstream of main signal package A is disconnected.

The monitoring control package stores the mask request information, which is received from main signal package A, in the storage unit (S3), generates the mask control information (S4), determines from the path information that main signal package B is a package to be masked (S5), and sends the mask control information to main signal package B via the apparatus internal bus (S6).

Main signal package B stores the mask control information in the storage unit (S7) and performs the mask processing for the failure ‘b’.

In the above-described examples having the configuration in which the multi-purpose apparatus internal bus is used as a path through which the mask request information and the mask control information for suppressing an alarm are sent, the following processing is performed for reducing a processing-speed delay that may be caused by the multi-purpose bus.

The mask request information, generated by the failure ‘a’ in the main signal package (A) 10₁, is sent to the monitoring control package 20 via the multi-purpose apparatus internal bus 40₁ (S2 in FIG. 3). In the examples, the monitoring control package 20 acquires the mask request information periodically from the main signal package, for example, at an interval of 500 msec.

After the processing (for example, scores of seconds) in the apparatus management/control unit 22 of the monitoring control package 20, the mask control information is sent to the main signal package (B) 10₂ via the multi-purpose apparatus internal bus 40₂ (S6 in FIG. 3). To prevent the failure ‘b’ in the main signal package (B) 10₂ from causing a false alarm to be generated because of a propagation delay of the mask control information, the monitoring control package 20 is equipped with a detection guard against an alarm notification from a main signal package. For example, the monitoring control package 20 determines that an alarm is generated if the alarm is generated continuously for 2.5 seconds and reports this alarm to the user terminal/upper-level monitoring system 50. In this way, the monitoring control package 20 avoids the generation of a false alarm that may be caused by a propagation delay.

In addition, the alarm display LED (Light Emitting Diode), which is provided on the front of the main signal package (B) 10₂ to indicate the generation of the failure ‘b’, is not turned on until the mask control information is received. For example, the alarm display LED is turned on with a delay of 2.5 seconds to prevent the alarm display LED from being turned on incorrectly by a propagation delay of the mask control information.

While the present invention has been described with reference to the examples above, it is to be understood that the present invention is not limited to the configuration of the examples above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A backbone transmission apparatus comprising:
a plurality of main signal packages; and
a monitoring control package connected to said plurality of main signal packages each via an apparatus internal bus; wherein
said monitoring control package comprises
a unit that collects an alarm about a failure, generated in one of said main signal packages, via the apparatus internal bus, and sends a control signal to one or plurality of other main signal packages, which will be effected by the failure, via the associated apparatus internal bus, said control signal being used for suppressing notification of an alarm to said monitoring control package in said one or plurality of other main signal packages.

2. A backbone transmission apparatus comprising:
a plurality of main signal packages; and
a monitoring control package connected to said plurality of main signal packages each via an apparatus internal bus; wherein
when a failure occurs in one of the main signal packages, said main signal package generates mask request information and sends the generated mask request information to said monitoring control package via the apparatus internal bus, said mask request information being used for requesting a suppression of an alarm; and wherein
said monitoring control package comprise
a unit that receives the mask request information from said main signal package, determines a main signal package to be masked based on path information on a main signal, and sends mask control information to said main signal package to be masked via the associated apparatus internal bus, said mask control information being used for suppressing notification of an alarm to said monitoring control package;
said main signal package to be masked, responsive to the mask control information from said monitoring control package, performing mask processing for an alarm to be notified to said monitoring control package.

3. The backbone transmission apparatus according to claim 2, wherein said monitoring control package periodically collects the mask request information from said main signal package.

4. The backbone transmission apparatus according to claim 2, wherein a detection guard against an alarm notification is set in said main signal package to be masked.

5. The backbone transmission apparatus according to claim 4 wherein an alarm display is suppressed for a detection guard period when a failure occurs in said main signal package to be masked.

6. The backbone transmission apparatus according to claim 2, wherein
said monitoring control package comprises:
an interface for connection to a user terminal/upper-level monitoring system;
an apparatus management/control unit that comprises: a path management unit that stores and manages path information on a main signal that is set via said user terminal/upper-level monitoring system and a unit that stores the mask request information and generates the mask control information from the path information on the main signal; and
an apparatus internal bus communication unit that performs communication with said main signal package via the apparatus internal bus.

7. The backbone transmission apparatus according to claim 2, further comprising a path control unit that is connected to said monitoring control package via the apparatus internal bus and controls main signal path switching.

8. An alarm control method for use in a backbone transmission apparatus which comprises a plurality of main signal packages; and a monitoring control package connected to said plurality of main signal packages each via an apparatus internal bus, said method comprising:
collecting, by said monitoring control package, an alarm about a failure, generated in one of said main signal packages, via the apparatus internal bus; and
sending, by said monitoring control package, a control signal to one or a plurality of other main signal packages, which will be effected by the failure, via the associated apparatus internal bus, said control signal being used for suppressing notification of an alarm to said monitoring control package in said one or plurality of other main signal packages.

9. An alarm control method for use in a backbone transmission apparatus which comprises a plurality of main signal packages; and a monitoring control package connected to said plurality of main signal packages each via an apparatus internal bus, said method comprising:
when a failure occurs in one of the main signal packages, generating, by said main signal package, mask request information and sending the generated mask request information to said monitoring control package via the apparatus internal bus;
receiving, by said monitoring control package, the mask request information from said main signal package, determining a main signal package to be masked based on path information, and sending mask control information to said main signal package to be masked via the apparatus internal bus, said mask control information being used for masking an alarm notification to said monitoring control package; and
performing, by said main signal package to be masked, mask processing for an alarm when the mask control information is received.

10. A monitoring control package apparatus connected to a plurality of main signal packages each via an apparatus internal bus, comprising:
a unit that receives mask request information from a main signal package in which a failure occurs, said mask request information being generated by said main signal package for requesting a suppression of an alarm;
a unit that determines a main signal package to be masked based on path information on a main signal and generates mask control information, said mask control information being used for suppressing notification of an alarm to said monitoring control package; and
a unit that sends the mask control information to the main signal package to be masked via the apparatus internal bus.

11. The monitoring control package apparatus according to claim 10, further comprising:
an interface for connection to a user terminal/upper-level monitoring system;
an apparatus management/control unit that comprises a path management unit that stores and manages path information on a main signal that is set via said user terminal/upper-level monitoring system; and a unit that stores the mask request information and generates the mask control information from the path information on the main signal; and
an apparatus internal bus communication unit that communicates with said main signal package via the apparatus internal bus.

12. A main signal package apparatus connected to a monitoring control package via an apparatus internal bus, said main signal package apparatus comprising:
a unit that generates mask request information when a failure occurs; and
a unit that sends the generated mask request information to said monitoring control package apparatus via the apparatus internal bus, said mask request information being used for requesting a suppression of an alarm.

13. A main signal package apparatus connected to a monitoring control package via an apparatus internal bus; wherein said monitoring control package receives mask request information from a main signal package in which a failure occurs, determines a main signal package to be masked based on path information on a main signal, and sends mask control information to the main signal package to be masked via the apparatus internal bus, said mask request information being used for requesting a suppression of an alarm, said mask control information being used for suppressing an alarm notification,
the main signal package apparatus comprising a unit that, responsive to the mask control information from said monitoring control package via the apparatus internal bus, masks notification of an alarm to said monitoring control package.

14. The main signal package apparatus according to claim 13, wherein a detection guard against an alarm notification is set in said main signal package to be masked.
